(19) United States
(12) Patent Application Publication
(10) Pub. No.: US 2010/0020424 A1
(43) Pub. Date: Jan. 28, 2010

(54) Combination mirror and recording/playback apparatus

(76) Inventor: Gwendolyn Maynor, Port Washington, MD (US)

Correspondence Address: Richard Elliott Halsey, 110 North Knollwood Drive, Wheaton, IL, 60187, US

(21) Appl. No.: 12/178,582

(22) Filed: Jul. 23, 2008

(51) Int. Cl. G02B 5/08

(52) U.S. Cl. 359/860; 359/838

(57) ABSTRACT

A mirror has a recording and playback apparatus, and a pre-recorded message plays aloud through at least one speaker on the mirror. The mirror is the typical size found in a common household. The record/playback apparatus may be a CD-ROM or other similar medium. The preferred embodiment for the invention is for use by individuals with low self-esteem, and the mirror may be used as a therapeutic tool for depression.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to a mirror. Specifically, this invention relates to a personal-sized mirror with a recording and playback apparatus, for recording or playing a message while using the mirror.

2. Description of the Related Art

A recording and playback apparatus with an image and voice recorded thereon is put into practice as a music CD, DVD, video disk, or the like. Similarly, mirrors are already put into practice, in the form of glass or a highly polished metal. There is no apparatus that combines the mirror with the recording and playback device.

The present invention provides the desired combination of a recording and playback apparatus and a mirror, in order for a user to view oneself while listening to a pre-recorded message.

### BRIEF SUMMARY OF THE INVENTION

The invention is a personal-sized mirror combined with a recording and playback apparatus.

### BRIEF DESCRIPTION OF THE SEVERAL VIEWS OF THE DRAWINGS

FIG. 1 is a front view of the mirror.

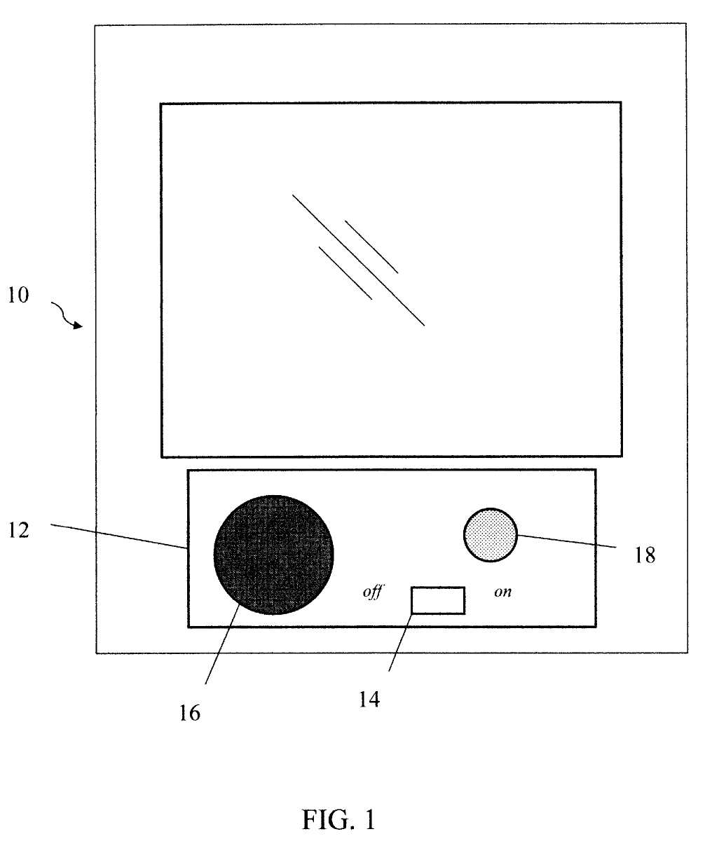

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. Those skilled in the art will recognize that there are many, and in the future may be additional, alternative embodiments which are recognized as equivalent because they provide the same function.

### DETAILED DESCRIPTION OF THE INVENTION

The invention is a mirror 10 with a recording and playback apparatus 12 connected to the mirror 10. A user (not shown) of the invention looks at herself in the mirror and activates the recording and playback apparatus 12 to either record or hear a pre-recorded message while using the mirror 10. The mirror 10 has a first activation means 14. The recording and playback apparatus 12 may be sound-activated, such as through a sound or a voice activation means.

The per-recorded message plays through at least one broadcasting means, such as a speaker 16. The volume is controlled through a variable sound controlling means, such as a volume dial 18. The message is preferable one of encouragement and positive compliment to the user to enhance and increase self-esteem.

Alternatively, an instructive pre-recorded message would play for the user, such as a message to remind the user of appointments or medications. The mirror 10 is of a personal size as a household mirror, such as in a washroom or on a piece of vanity furniture. The recording and playback apparatus 12 may be a CD-ROM or similar apparatus medium.

In the preferred embodiment, the user actuates the playback feature to hear a pre-recorded message replayed aloud. More than one message may be recorded. The preferred embodiment for the invention is for use by individuals with low self-esteem, as a means for treating said individuals. The mirror 10 is a tool for improving self-image, and is may be used as a tool for therapeutic depression. The pre-recorded message of encouragement and reassurance, in order to help the user cope with everyday issues related to depression.

While certain preferred embodiments of the present invention have been disclosed in detail, it is to be understood that various modifications may be adopted without departing from the spirit of the invention or scope of the following claims.

1. A mirror in combination with speakers and an audio recording playback device mounted on said mirror, comprising:
A means to actuate said audio device for recording at least one message;
At least one means to actuate said device for playing said message;
An information recording medium housed in said device.

2. The mirror of claim 1, wherein said pre-recorded message is a statement of positive self-esteem.

3. The mirror of claim 1, wherein said pre-recorded message is a statement of instruction.

4. The mirror of claim 1, wherein said means to actuate said audio device is a voice-recognition device.

5. The mirror of claim 1, wherein said means to actuate said audio device is a sound-recognition device.
